(19) United States
(12) Patent Application Publication
(10) Pub. No.: US 2008/0165537 A1
(43) Pub. Date: Jul. 10, 2008

(54) LED lamp with heat distribution capability

(76) Inventor: Wen-Chin Shiau, Kuei-Shan Hsiang (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/786,341

(22) Filed: Apr. 10, 2007

(30) Foreign Application Priority Data
Jan. 4, 2007 (TW) 096100309

(51) Int. Cl. F21V 29/00

(52) U.S. Cl. 362/294; 362/373

(57) ABSTRACT

A light emitting diode (LED) lamp includes a housing, and a heat conducting member made of a highly thermally conductive material. The heat conducting member includes a base plate that is mounted on the housing and that has one side opposite to the housing, and at least one heat conducting fin extending from the base plate away from the housing. The LED lamp further includes a light emitting diode unit mounted on the side of the base plate.

### CROSS-REFERENCE TO RELATED APPLICATION

This application claims priority of Taiwanese Application No. 096100309, filed on Jan. 4, 2007.

### BACKGROUND OF THE INVENTION

1. Field of the Invention

The invention relates to a light emitting diode (LED) lamp, more particularly to a LED lamp with heat distribution capability.

2. Description of the Related Art

As shown in FIG. 1, a conventional LED lamp, such as a head lamp or a flashlight, includes a housing 1 that has first and second end portions 101, 102. A power switch 10 is disposed at the first end portion 101, and a cover 11 is coupled to the housing 1 at the second end portion 102. The housing 1 confines a receiving space 100 between the first and second end portions 101 and 102 for receiving a battery set 103. The housing 1 is formed with an opening 12 between the first and second end portions 101 and 102, and further has a pair of supporting plates 13 extending across the opening 12. The housing 1 further includes a positioning seat 16 mounted to the supporting plates 13 at one side opposite to the receiving space 100. The conventional LED lamp further includes a light emitting diode unit 2 and a reflector 14, both of which are mounted to the positioning seat 16 at the side opposite to the receiving space 100, and a lamp cap 15 mounted to the housing 1 to enclose the reflector 14 and the light emitting diode unit 2.

However, since the housing 1, the supporting plates 13, the positioning seat 16, the reflector 14, and the lamp cap 15 are all made from plastic, highly concentrated heat generated by the light emitting diode unit 2 is likely to cause damage to these components, thereby resulting in a relatively short service life for the conventional LED lamp.

### SUMMARY OF THE INVENTION

Therefore, the object of the present invention is to provide a LED lamp with heat distribution capability to avoid component damage due to high heat concentration.

Accordingly, a LED lamp of the present invention comprises a housing, and a heat conducting member made of a highly thermally conductive material. The heat conducting member includes a base plate that is mounted on the housing and that has one side opposite to the housing, and at least one heat conducting fin extending from the base plate away from the housing. The LED lamp further comprises a light emitting diode unit mounted on the side of the base plate.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional LED lamp;

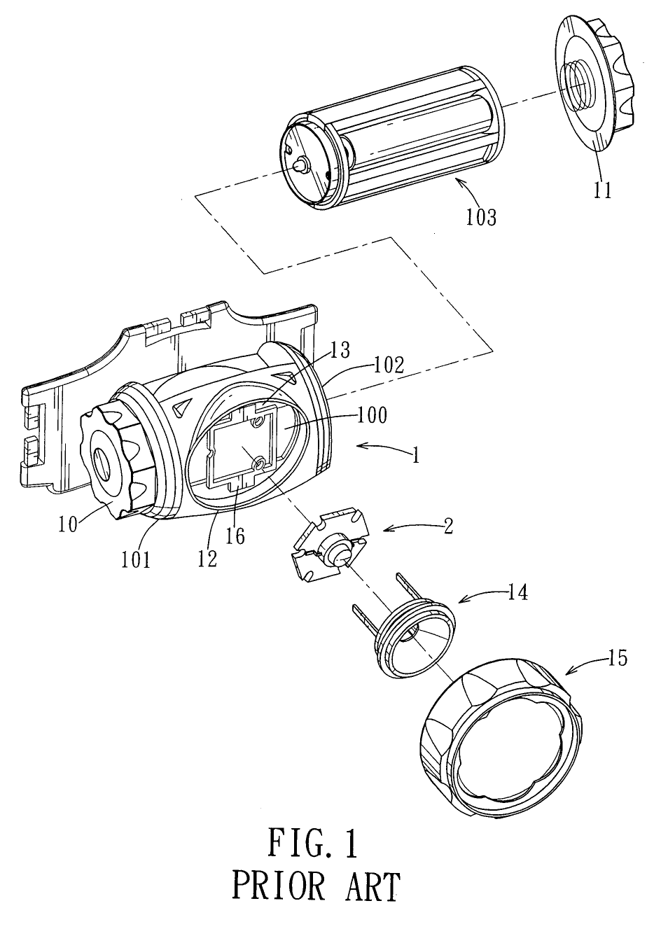

FIG. 2 is an exploded perspective view of a preferred embodiment of a LED lamp with heat distribution capability according to the invention; and

FIG. 3 is a fragmentary, partly sectional, schematic view of the preferred embodiment, illustrating a heat conducting member, a light emitting diode unit, a reflector, and a lamp cap.

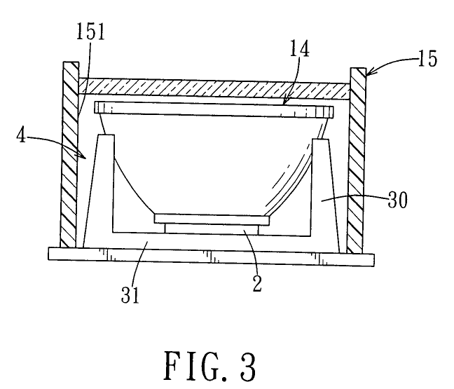

### DETAILED DESCRIPTION OF THE PREFERRED EMBODIMENT

Before the present invention is described in greater detail, it should be noted that like elements are denoted by the same reference numerals throughout the disclosure.

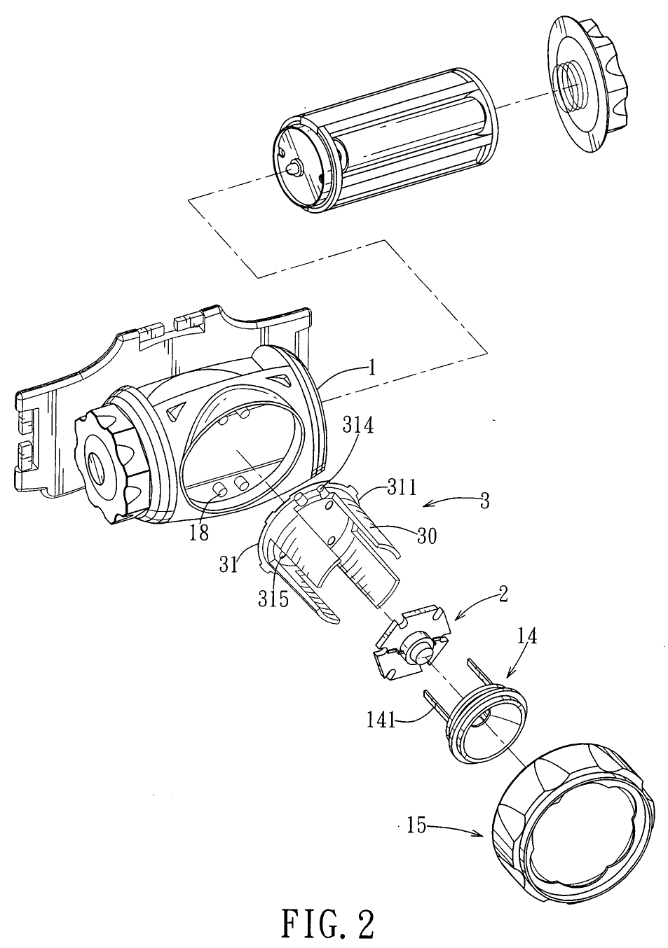

As shown in FIG. 2, the preferred embodiment of a LED lamp according to the present invention comprises a housing 1, a heat conducting member 3 including a base plate 31 that is mounted on the housing 1, that has one side opposite to the housing 1, and that has a peripheral portion 311, and a high wattage light emitting diode unit 2 mounted on the side of the base plate 31. The heat conducting member 3 further includes four curved heat conducting fins 30 that extend from the peripheral portion 311 of the base plate 31 away from the housing 1, that are angularly spaced apart from each other, and that surround the light emitting diode unit 2. The heat conducting member 3 is made of a highly thermally conductive material.

The preferred embodiment further comprises a reflector 14 mounted to the heat conducting member 3, and a lamp cap 15 mounted to the housing 1 to enclose the reflector 14 and the heat conducting member 3. The lamp cap 15 has a cap wall 151 spaced apart from the reflector 14 and cooperating with the reflector 14 to define a space 4 within which the heat conducting fins 30 are disposed. The reflector 14 is formed with three positioning legs 141 (only two are visible), and the base plate 31 is formed with three first positioning holes 315 to position the positioning legs 141, respectively. The housing 1 is provided with a plurality of positioning protrusions 18, and the peripheral portion 311 of the base plate 31 is formed with a plurality of second positioning holes 314 that correspond in position with the positioning protrusions 18 to engage the positioning protrusions 18, respectively.

When the preferred embodiment is turned on, the light emitting diode unit 2 will generate a large amount of heat that is conducted to the heat conducting member 3 and distributed by the heat conducting fins 30 to the space 4 within the reflector 14 and the lamp cap 15. Compared to the conventional LED lamp, the presence of the heat conducting member 3 results in less heat absorption by the housing 1, the reflector 14 and the lamp cap 15, thereby avoiding damage to the same. Consequently, the present invention is more durable than the prior art.

It should be noted that, while this invention is exemplified using four heat conducting fins 30, three positioning legs 141, and a plurality of positioning protrusions 16, only one heat conducting fin 30, one positioning leg 141, and one positioning protrusion 16 may be employed in other embodiments of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light emitting diode (LED) lamp comprising:
a housing;
a heat conducting member made of a highly thermally conductive material and including a base plate that is mounted on said housing and that has one side opposite to said housing, and at least one heat conducting fin that extends from said base plate away from said housing; and
a light emitting diode unit mounted on said one side of said base plate.

2. The LED lamp as claimed in claim 1, wherein said base plate has a peripheral portion from which said heat conducting fin extends.

3. The LED lamp as claimed in claim 2, wherein said heat conducting fin is a curved fin.

4. The LED lamp as claimed in claim 3, further comprising a reflector mounted to said heat conducting member, and a lamp cap mounted to said housing to enclose said reflector and said heat conducting member, said lamp cap having a cap wall spaced apart from said reflector and cooperating with said reflector to define a space within which said heat conducting fin is disposed.

5. The LED lamp as claimed in claim 4, wherein said reflector is formed with a positioning leg, and said base plate is formed with a first positioning hole to position said positioning leg.

6. The LED lamp as claimed in claim 5, wherein said housing is provided with a positioning protrusion, and said peripheral portion of said base plate is formed with a second positioning hole to engage said positioning protrusion.

7. The LED lamp as claimed in claim 6, wherein said heat conducting member includes four of said heat conducting fins that are angularly spaced apart from each other on said peripheral portion of said base plate and that surround said light emitting diode unit.
